(19) United States
(12) Patent Application Publication
(10) Pub. No.: US 2018/0030950 A1
(43) Pub. Date: Feb. 1, 2018

(54) ANTI-DROUGHT AND ANTI-FLOOD BY STILL WATER CIRCULATION GENERATION

(71) Applicant: Taiping ZHONG, Yueyang (CN)

(72) Inventor: Taiping ZHONG, Yueyang (CN)

(21) Appl. No.: 15/693,451

(22) Filed: Aug. 31, 2017

Related U.S. Application Data
(63) Continuation of application No. PCT/CN2016/070807, filed on Jan. 13, 2016.

(30) Foreign Application Priority Data
Mar. 9, 2015 (CN) 201510101506.6

(51) Int. Cl. F03B 13/06; H02K 7/18; F03B 13/08

(52) U.S. Cl. CPC F03B 13/06; F03B 13/08; H02K 7/1823; F05B 2220/706; F05B 2260/505; F03B 17/005

(57) ABSTRACT

The present disclosure discloses anti-drought and anti-flood by still water circulation generation. A pit (4) is dug near water (1), a water turbine (6) and a generator (7) are placed at the bottom of the pit, the water (1) on the pit (4) is released in a planned way along a water discharge pipe to drive a water turbine (6) to operate, a blade (11) and a chain (12) are meshed with an upper gear (9) and a lower gear (10), the upper gear (9) is driven by an electric motor (13) to drive the blade (11) to rotate such that the blade (11) inside a water outlet pipe moves upwards with water (1) circularly, thereby driving the generator to continuously generate power. The present invention is able to meet the power generation demand of users and is also capable of adjusting and meeting the local water consumption.

### TECHNICAL FIELD

The anti-drought and anti-flood by still water circulation generation of the present invention is suitable for a region or a city and comprises following steps: digging a pit with 10-100 m depth or more near water, connecting a water turbine with a generator and placing at a bottom of the pit, opening a hole on the pit and releasing water of the pit as planned along a water discharge pipe to drive the water turbine at the bottom to rotate, connecting a blade and a chain, the blade and the chain are meshed with an upper gear of the pit and a lower gear of the pit, the upper gear of the pit is driven by an electric motor to drive the blade to rotate in a straight line on the water outlet pipe and in the water outlet pipe, so that the blade in the water outlet pipe moves upwards with water in a circulation manner. Carrying water driving the water turbine to rotate by the blade to be level with water of the pit or 10-50 meters higher than the water of the surface of the pit and power is generated again, and the discharging water is divided into circulation water, anti-drought water, and anti-flood water to be discharged, and if the discharging water is required to generate power circularly, turn off two channels as required, communicate, converge and restore the water with equal flow discharges, equal flow outlet and unequal flow velocity, the water is circularly released and circularly discharged, or the water is constantly released and constantly discharged, making the water turbine keep running at high speed and driving the generator to keep generating electricity, so there is no need for field power supply, electricity demand of a region or a city can be met without power supply from other places, and annual water consumption of an region or a city can be adjusted and controlled. If the total capacity of the local water lake and pit water and the total annual water consumption are estimated, the total capacity and total water consumption is assumed as not equal, then all the local water (processed water), rain, ice and snow melt water are brought to the lake and the pit, if it is not enough, river water is supplemented until the total capacity and total water consumption are equal. If there is a strong rainfall of 150-200 millimeters per hour, the sharp rise in water will cause floods, it is necessary to design a device for discharging 150-200 millimeters of water in an hour. If one device is not enough, then design more, in short, the water cannot be rose rapidly, and water usage of local residents needs to be guaranteed.

According to the requirement of electricity, a power station as large as the Three Gorges can be built along the Yangtze River per 30 kilometers, which requires no water interception and can be used to discharge water and generate electricity by digging a pit along both sides of the river, and has no effect on water transport and water discharge. It can be built along the lake, and along the coast.

### BACKGROUND OF THE INVENTION

All the power generation industries around the world are now looking for resources to generate electricity, resulting in damage to the earth, environment and air pollution, harm to humans, excessive submerged land, excessive land occupation, and too much space occupation, even conflict and war. Nevertheless, the resources still can not meet the needs of human electricity consumption even if fully utilized due to limitation, especially human and material resources are consumed greatly. In order to survive, all humans have to face this situation, moreover, the world has no ability to complete control water disaster, although the mankind has taken many measures on the drought and flood problems, the effect is not significant.

### SUMMARY OF THE INVENTION

In view of the shortcomings of the above-mentioned techniques, the purpose of the present invention is to provide anti-drought and anti-flood by still water circulation generation, which is used to replace various forms of power generation with limited still water and water, is able to meet the power generation demand of users and also capable of adjusting and meeting the local water consumption. The present invention is achieved by the following technical scheme:

Anti-drought and anti-flood by still water circulation generation, comprising:

digging a pit near water; when water of the pit is released, a certain force is generated;

releasing water; opening a hole on the pit and releasing the water in a planned way along a water discharge pipe to drive a water turbine to operate; determining a wheel size of a water turbine generator or length of a blade by local electricity demand by using a lever principle, distributing the water by using four or more than four pipes, releasing the water vertically, uniformly and evenly around a wheel of the water turbine generator or the blade, and driving the wheel or the blade to rotate at the most suitable angle; and

discharging water; carrying water driving the water turbine to rotate by the blade to be level with water of the pit, discharging the water as required by dividing into circulation water, anti-drought water, and anti-flood water, releasing and discharging the water circularly or constantly, and driving the water turbine to keep running at high speed and driving a generator to keep generating electricity.

The anti-drought and anti-flood by still water circulation generation, further comprising a water outlet pipe with a slope of 1:10 or different proportions from a surface of the pit to the bottom of the pit; the smaller slope of the water outlet pipe is, more labor-saving and better effect of the blade carrying the water; the water outlet pipe is tunneled from the bottom of the pit to the ground to reduce excessive use of the ground area.

The blade and a chain are connected with each other, the chain and the blade are meshed with an upper gear of the pit and a lower gear of the pit, the upper gear of the pit is driven by an electric motor to drive the blade to rotate in a straight line on the water outlet pipe and in the water outlet pipe, so that the blade in the water outlet pipe moves upwards with water in a circulation manner.

The discharging water is discharged at a position higher 10-50 meters or more than the water of the surface of the pit and power is generated again, and the discharging water is divided into three channels: circulation water (used to cycle in the absence of water), anti-drought water, and anti-flood water to be discharged, and if the discharging water is required to generate power circularly, turn off two channels as required.

Ice and snow are melted by electric heating in an alpine region, so that water flows circularly and generates power constantly.

A good river interception ensures smooth flow of water transport according to requirements of water transport, so that excess water can be discharged and deficient water can be supplemented timely.

The anti-drought and anti-flood by still water circulation generation, further comprising electricity and water, so that high pole erection and another channel for cross-regional long-distance transport are not needed.

The anti-drought and anti-flood by still water circulation generation of the present invention uses limited still water and water to generate power and anti-drought and anti-flood; it can replace and surpass the modern nuclear power generation, fire power generation, water power generation (water cutoff power generation), solar power, wind power generation and ensure sufficient power, it can infinitely replace and surpass the current use of electric pumping and resist drought, floods, and ensure that annual production and living water of local farmers and residents (except the tsunami and floods over the levee), and it can replace and surpass various uses of coal, natural gas and liquefied petroleum gas in the house of our country farmers and residents with low cost; it generates power and manages water simply, environmental friendly and high effectively; it can reduce the temperature of the weather, greatly reduce the extreme weather, protect people's health, and protect the natural ecological balance.

### BRIEF DESCRIPTION OF THE DRAWINGS

FIG. 1 is a schematic diagram of the apparatus of the present invention;

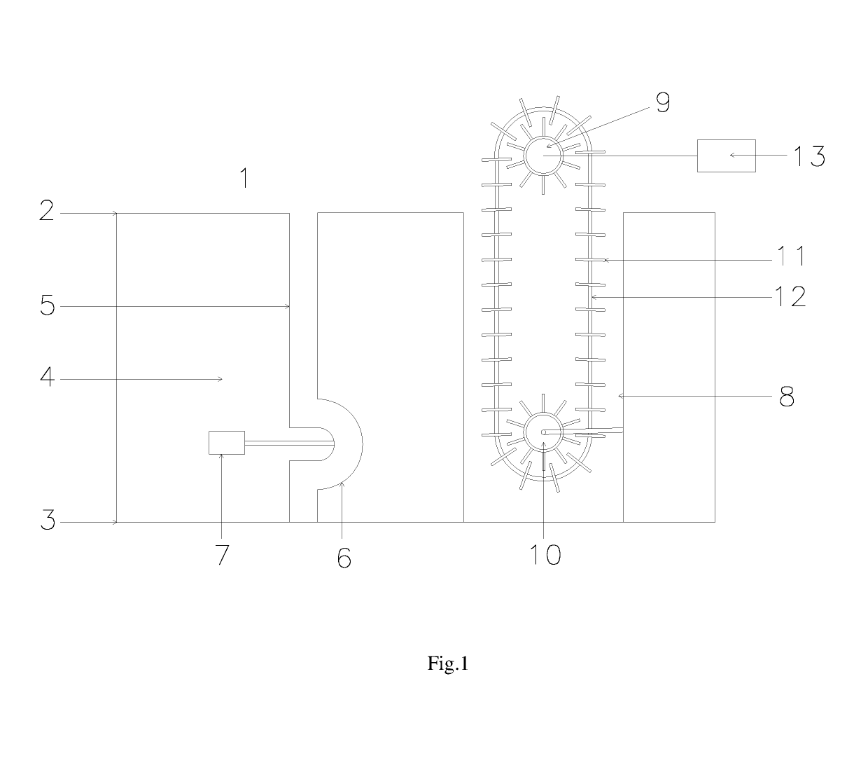

FIG. 2 is a schematic diagram of an embodiment of the present invention;

In the figure: 1 is the water; 2 is an upper end of the pit; 3 is the bottom of the pit; 4 is the pit; 5 is the water discharge pipe; 6 is the water turbine; 7 is the generator; 8 is the water outlet pipe; 9 is the upper gear; 10 is the lower gear; 11 is the blade; 12 is the chain; and 13 is the electric motor.

### DETAILED DESCRIPTION OF THE INVENTION

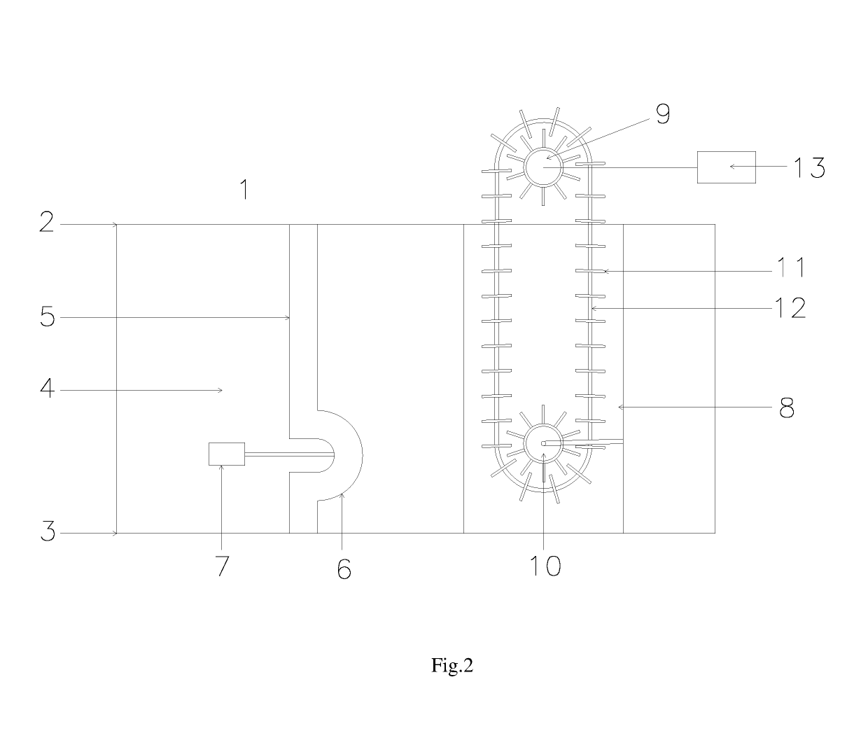

As shown in FIG. 2, the water turbine 6 and the generator 7 are placed at the bottom of the pit 3, opening a hole on an upper end of the pit 2, the water 1 is released along the water outlet pipe 5 as planned to drive the water turbine 6 at the bottom of the pit 3 to rotate, the blade 11 and the chain 12 are meshed with an upper gear 9 of the upper end of the pit 2 and the lower gear 10 at the bottom of the pit 3, the upper gear 9 of the upper end of the pit 2 is driven by an electric motor 13, driving the blade 11 to rotate along with the lower gear 10 in a straight line on the water outlet pipe 8 and inside the water outlet pipe 8, such that the blade 11 inside the water outlet pipe 8 moves upward with the water 1, the water driving the water turbine 6 to rotate is carried by the blade 11 to be level with the water 1 of the upper end of the pit 2, converged and restored. The water can be divided into circulation water, anti-drought water and anti-flood water to be discharged as required, such as the water 1 is circularly released along the water discharge pipe 5 and circularly discharged in the water outlet pipe 8, or the water is constantly released along the water discharge pipe 5 and constantly discharged in the water outlet pipe 8, making the water turbine 6 keep running at high speed and driving the generator 7 to keep generating electricity.

What is claimed is:

1. Anti-drought and anti-flood by still water circulation generation, characterized by comprising digging a pit near water; when water of the pit is released, a certain force is generated.

2. The anti-drought and anti-flood by still water circulation generation of claim 1, characterized by comprising releasing water; opening a hole on the pit and releasing the water in a planned way along a water discharge pipe to drive a water turbine to rotate; determining a wheel size of a water turbine generator or length of a blade by local electricity demand by using a lever principle, distributing the water by using four or more than four pipes, releasing the water vertically, uniformly and evenly around a wheel of the water turbine generator or the blade, and driving the wheel or the blade to rotate at the most suitable angle.

3. The anti-drought and anti-flood by still water circulation generation of claim 1, characterized by comprising discharging water; carrying water driving the water turbine to rotate by the blade to be level with water of the pit, discharging the water as required by dividing into circulation water, anti-drought water, and anti-flood water, releasing and discharging the water circularly or constantly, and driving the water turbine to keep running at high speed and driving a generator to keep generating electricity.

4. The anti-drought and anti-flood by still water circulation generation of claim 1, further comprising a water outlet pipe with a slope of 1:10 or different proportions from a surface of the pit to the bottom of the pit; the smaller slope of the water outlet pipe is, more labor-saving and better effect of the blade carrying the water; the water outlet pipe is tunneled from the bottom of the pit to the ground to reduce excessive use of the ground area.

5. The anti-drought and anti-flood by still water circulation generation of claim 1, characterized by the blade and a chain are connected with each other, the chain and the blade are meshed with an upper gear of the pit and a lower gear of the pit, the upper gear of the pit is driven by an electric motor to drive the blade to rotate in a straight line on the water outlet pipe and in the water outlet pipe, so that the blade in the water outlet pipe moves upwards with water in a circulation manner.

6. The anti-drought and anti-flood by still water circulation generation of claim 1, characterized by the discharging water is discharged at a position higher 10-50 meters or more than the water of the surface of the pit and power is generated again, and the discharging water is divided into three channels: circulation water (used to cycle in the absence of water), anti-drought water, and anti-flood water to be discharged, and if the discharging water is required to generate power circularly, turn off two channels as required.

7. The anti-drought and anti-flood by still water circulation generation of claim 1, characterized by ice and snow are melted by electric heating in an alpine region, so that water flows circularly and generates power constantly.

8. The anti-drought and anti-flood by still water circulation generation of claim 1, characterized by a good river interception ensures smooth flow of water transport according to requirements of water transport, so that excess water can be discharged and deficient water can be supplemented timely.

9. The anti-drought and anti-flood by still water circulation generation of claim 1, characterized by further comprising electricity and water, so that high pole erection and another channel for cross-regional long-distance transport are not needed.

10. The anti-drought and anti-flood by still water circulation generation of claim 1, characterized by each user only needs start-up duty fee, equipment maintenance fees and equipment depreciation fees to use the electricity and water as needed under the premise of adequate water.
